(19) United States
(12) Patent Application Publication
(10) Pub. No.: US 2013/0013339 A1
(43) Pub. Date: Jan. 10, 2013

(54) SYSTEMS AND METHODS FOR MEDICAL DATA STORAGE AND RETRIEVAL

(75) Inventors: Paul Goldman, Pompano Beach, FL (US); Edward Goldman, Boca Raton, FL (US); Lloyd Chesney, West Palm Beach, FL (US); Michael Harwitz, Arcadia, CA (US)

(73) Assignee: Practice Communications LLC, Boca Raton, FL (US)

(21) Appl. No.: 13/283,249

(22) Filed: Oct. 27, 2011

Related U.S. Application Data
(60) Provisional application No. 61/407,244, filed on Oct. 27, 2010.

(51) Int. Cl. G06Q 50/22

(52) U.S. Cl. 705/3

(57) ABSTRACT

In accordance with one embodiment, a system for encoding medical data is provided. The system includes a data processing module to process medical data from any given format to a Continuity of Care Record (CCR) standard. The system for encoding medical data further includes a data export module. The data export module exports the medical data after processing into a CCR format. Additionally, the system also includes a control module for providing operational instruction to the data processing module. The control module may also provide operational instruction for data export module.

### CLAIM OF PRIORITY UNDER 35 U.S.C. §120

The present Application for patent claims priority to Provisional Application No. 61/407,244 entitled “ELECTRONIC MEDICAL DATA STORAGE AND RETRIEVAL SYSTEM AND METHOD,” filed Oct. 27, 2010. The contents of these disclosures are expressly incorporated by reference herein.

### BACKGROUND OF THE INVENTION

Embodiments of the subject matter disclosed herein generally relate to medical data, and more particularly to systems and methods for storage and retrieval of medical data.

In a hospital or a clinical environment a plurality of information is generated for individual patient. For example, the information generated may include patient's name, age, sex and weight, doctor's notes, patient's symptoms, diagnoses, treatments and procedures administered to patient, patients' drug history, patient's allergies, prescribed medicines and the like. As the volume of medical information generate for patient increases, there is an increasing need for handling the medical data in an efficient way.

Generally, a patient may be handed a paper copy of the patient's medical data. However, when the patient medical data is required by another hospital or clinic or in an emergency room, the patient may not have the patient's medical data. Alternatively, the patient's medical data may be transmitted between different hospitals or clinics as fax or other electronic means. The medical data format transmitted between different hospitals or clinics may lack consistency. Moreover, the readability of the medical data may itself be an issue.

Over the years, a number of medical data communication standards have emerged. The AMERICAN RECOVERY AND REINVESTMENT ACT OF 2009 mandated the implementation of Electronic Medical data for all Medical Providers. The American Society for Testing and Materials (ASTM) along with other health informatics vendors and academic institutions developed a consensus health record standard specification namely Continuity of Care Record (CCR). The CCR, among other thing, provides standard for content, organization and language.

However, a need exists in retrieving patient's medical data in an efficient and a timely manner, including but not limited to, retrieving patient's medical data for Emergency room physician.

### SUMMARY

In accordance with one embodiment, a system for encoding medical data is provided. The system includes a data processing module to process medical data from any given format to a Continuity of Care Record (CCR) standard. The system for encoding medical data further includes a data export module. The data export module exports the medical data after processing into a CCR format. Additionally, the system also includes a control module for providing operational instruction to the data processing module. The control module may also provide operational instruction for data export module.

In accordance with one embodiment, a method for encoding medical data is provided. The method for encoding medical data includes configuring a data processing module to format the medical data from any given data format into a Continuity of Care Record (CCR) standard. The method for encoding medical data also includes exporting the medical data using a data export module. For example, the data is exported in the CCR standard. Additionally, the method includes using a control module to provide operational instructions to at least the data processing module and the data export module via a control module.

### BRIEF DESCRIPTION OF THE DRAWINGS

The drawings, in which like numerals represent similar parts, illustrate generally, by way of example, but not by way of limitation, various embodiments discussed in the present document.

FIG. 1 illustrates a method for retrieving patient medical data in accordance with an embodiment.

FIG. 2 illustrates a method for processing patient medical data in accordance with an embodiment.

FIG. 3 illustrates fields in a Continuity of Care Record (CCR) report that may be displayed to a healthcare practitioner in accordance with an embodiment.

FIG. 4 is an exemplary embodiment of a medical data encoding system.

FIG. 5 illustrates an implementation of a communication application process in accordance with an embodiment.

FIG. 6 illustrates a process to store and retrieve medical data in accordance with an embodiment.

### DETAILED DESCRIPTION

The foregoing summary, as well as the following detailed description of certain embodiments of the subject matter set forth herein, will be better understood when read in conjunction with the appended drawings. As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

In the following detailed description, reference is made to the accompanying drawings which form a part hereof, and in which are shown by way of illustration specific embodiments in which the subject matter disclosed herein may be practiced. These embodiments, which are also referred to herein as “examples,” are described in sufficient detail to enable those skilled in the art to practice the subject matter disclosed herein. It is to be understood that the embodiments may be combined or that other embodiments may be utilized, and that structural, logical, and electrical variations may be made without departing from the scope of the subject matter disclosed herein. The following detailed description is, therefore, not to be taken in a limiting sense, and the scope of the subject matter disclosed herein is defined by the appended claims and their equivalents. In the description that follows, like numerals or reference designators will be used to refer to like parts or elements throughout. In this document, the terms “a” or “an” are used, as is common in patent documents, to include one or more than one. In this document, the term “or” is used to refer to a nonexclusive or, unless otherwise indicated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

In one embodiment of the subject matter disclosed herein, a method for encoding medical data is provided. For example, the encoding may define a rule for converting medical data from the first format into a second format, wherein the first format and the second format may be different. For example, the first format may be a scan of charts, scan of old medical records, a doctor's transcript, digital communication in medicine (DICOM) data, an electronic medical record (EMR), or any combination thereof. However, the method for encoding is not limited to simply transforming data from the first format to the second format. The method for encoding medical data may include configuring a data processing module to format the medical from a first format into a Continuity of Care Record (CCR) standard. Optionally, the data processing module may be configured to export a data in any other format. For example, the output format may only contain non-image data. Alternatively, the output format may have both the non-image data and image data within one file.

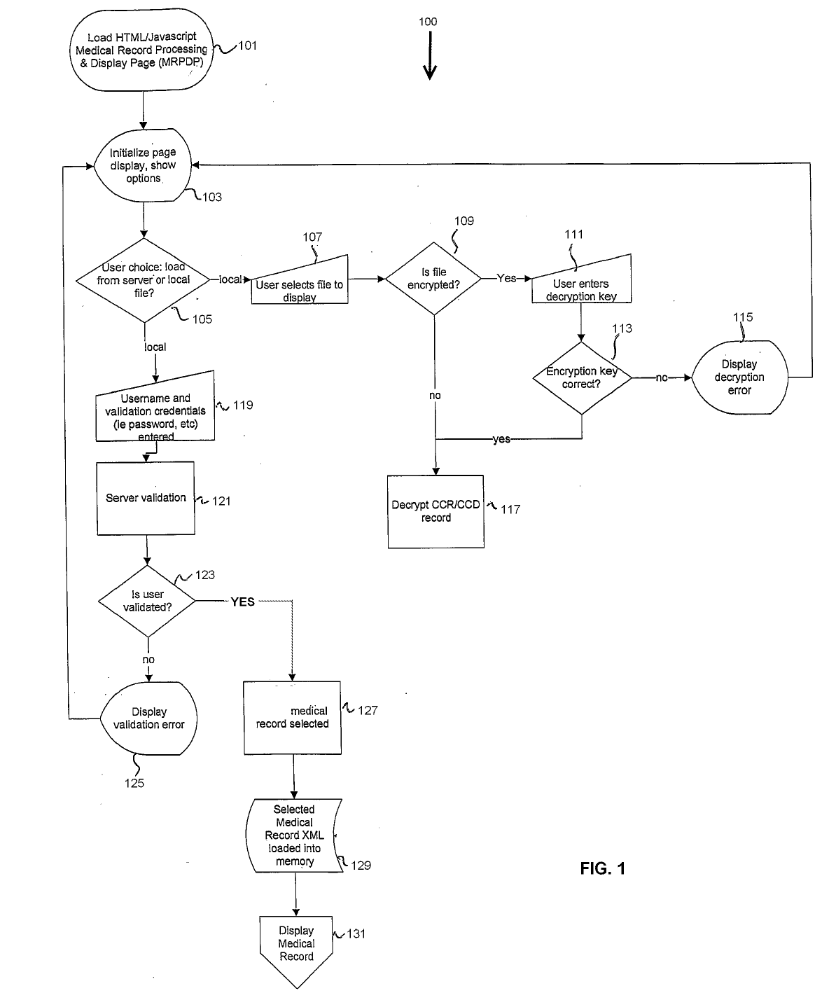

FIG. 1 illustrates a method 100 for retrieving patient medical data in accordance with an embodiment. At 101a computer disc (CD) or other portable digital storage media is inserted into an emergency room computer system, for example. Optionally, the method 100 may involve exporting the medical data to a semiconductor chip. For example, the semiconductor chip may be Radio-frequency identification (RFID) readable chip, such that the chip may transfer medical data stored on the chip to an RFID reader when the RFID reader is placed in close proximity of the semiconductor chip. Alternative embodiments may comprise exporting the medical data to a memory card that may be read by a memory card reader. For example, the memory card may be a Secure Digital (SD) card, or any flash memory card format.

In another embodiment of the subject matter disclosed herein, the method 100 may include configuring the data export module to export the medical data to an insurance card. The insurance card may be carried by a patient at all times thereby making the patient's personalized medical data available at all time. For example, in case of an emergency the patient's medical data may be retried by an emergency room physician using the patient's insurance card when the patient may be unable to communicate with the physicians.

In yet another embodiment, the method 100 may include exporting the medical data directly to a Healthcare Information System (HIS). Such that the HIS may be available to physicians. In one embodiment, the HIS may be accessible by any healthcare provider. Optionally, HIS may be accessible when authorized by the patient. The HIS may further have a front end to allow a user to interact with the HIS. The front end of HIS may be a data only query module or may be a front end of a picture archiving system (PACS). For example, the HIS may be configured to selectively share the medical data as authorized by patient. Such that a patient may choose the medical data that may be available to a specialist or healthcare provider.

Additionally, the method 100 may merge the medical data exported by the data export module with the existing medical data on HIS. As other healthcare providers produce the Medical CDs, additional healthcare information for an individual patient becomes known. The incoming CD request is processed and patient information archived. A follow-up process separates the new information and appends it to the original CCR file with appropriate notations and auditing backup. If the patient has selected this updating feature of the medical information CD, an up-to-date Medical Information CD will be produced.

The CD may include code that allows the automatic launch of a browser application, for example, once it is inserted in the computer system. The method 100 may also includes configuring the data export module to export software along with CCR standard medical data, the software configured to display the exported medical data in a browser. For example, the CD may include code, such as JavaScript, used to initialize the browser (103). For example, the software exported along with the medical data may be configured to direct the browser to display a particular set of fields for entering information needed for processing medical records. In one embodiment of the subject matter disclosed herein, the CCR file in its entirety is placed in a wallet sized CD or other electronic media, together with code that allows extraction of the information from any computing device, independent of that device's operating system and browser. The data may be preset so that it can be uploaded into any modern computer system with an industry standard Internet browser in simple HTML format without requiring special programs on the reading system. The information may be stored in plain text or in encrypted form. The system and method of the subject matter disclosed herein thus allows a patient to carry a CD/electronic media in his/her wallet/purse with the medical insurance card.

In one embodiment of the subject matter disclosed herein the method 100 further includes configuring the software to at least selectively share medical data with a Healthcare Information System (HIS). The HIS may be part of a hospital information system, or may be a global information system accessible by physicians upon receiving consent by a patient. Optionally, the HIS may be any Patient Health Record (PHR) system used by insurance companies. The HIS may be certified by the Certification Commission for Healthcare Information Technology (CCHIT).

The participating Healthcare providers may offer to the patient an online Patient Health Record (PHR) based on the CCR information. This may be implemented as a highly secure website, with all Healthcare information for the individual patient. The patient can review, edit some sections or request changes of information by contacting the originating healthcare provider for clarification. Guest access can be granted to healthcare providers which do not use electronic medical records (EMRs) or other electronic system to record patient data as a result of medical consultations to view or enter data.

The transfer of data and presentation thereof may take place automatically and without any specific browser or operating system requirements. This may be achieved in one or more ways as recognized by persons skilled in the art and as described, for example, in one or more of the following references: U.S. Pat. No. 6,983,415; U.S. Pat. No. 6,119,153; http://lifehacker.com/182792/hack-attack-quicklaunch-your-usb-workspace; and/or http://portableapps.com/apps/internet/firefox_portable (portable Firefox).

In another embodiment, the subject matter disclosed herein integrates contained in the medical information CD into a Health Information Exchange (HIE) system. An HIE may be defined as the mobilization of healthcare information electronically across organizations within a region, community or hospital system.

After burning the CCR into a CD or other portable digital storage media (e.g., a memory stick), the CCR file may be archived in a secure data repository. While patients may have access to the information on the CCR, only physicians or authorized persons may make changes to the CCR and/or transfer CCR information to a CD. As discussed above, a patient may request a specific change to a CCR so that the physician or other authorized user can make the change.

Over time, other medical service providers may be submitting CCRs for production of an updated medical information CD or portable digital media storage for a patient. In one embodiment, the CCR information may be archived separately and then sorted for new medical data and the new information appended to the original CCR record. This inter-linking ensures that the information on any new medical information CD contains the latest available data for a patient. Since the information is in original CCR format (an ASTM Standard) on all medical information CDs, other providers may upload the CCR information directly into their electronic record systems. The standardized CCR format can be converted for communication into different formats for individual organizational needs.

In another embodiment, the invention utilizes the medical information CD production as a foundation for the exchange of CCR information in a native format among healthcare providers. For example, the subject matter disclosed herein includes establishing bidirectional secure communications among the healthcare providers and permitting updating the patients' original CCR file with information generated by all providers, resulting in an always current CCR for the patient(s). This bidirectional secure communication network may be used to implement an HIE.

For example, The format of the data and the code for launching an application that displays the data in a computer system when the CD or portable digital media storage is inserted in that computer allows any patient to carry their medical information in a convenient size and a healthcare provider to access patient information in emergency situations when the patient is unconscious. Additionally, the subject matter disclosed herein does not require any additional software to read the CD and open CCR from a standard browser. The software that may be exported along with the CCR format may also be configured to auto-run the CD upon insertion of the CD into a computer system.

The data in the medical information CD carries human readable patient name and the contact information of the physician that produced or burned the CD or portable digital media storage device. The medical data that is exported using the export module may be configured to be accessible in a read-only format. For example, once the medical data is written on to the CD or portable digital media, it cannot be altered or changed directly by the patient.

Optionally, the method 100 may further comprise merging the exported medical data with an existing medical data on the HIS. In one embodiment, the software exported along with the medical data may be configured to automatically locate the data on the HIS and merge the newly exported medical data with the existing medical data on the HIS. For example, the healthcare providers may use a CD to updated healthcare information for a patient resulting in “always current” medical information CD or portable digital storage media. Alternatively, the software may also be configured to remove redundant medical data or remove duplicate data from the HIS.

The software exported along with the medical data may be a standalone software program. The software may be independent of operating system. For example, the software exported with medical data may run on a Windows operating system, a Macintosh operating system, Linux operating system, Ubuntu operating system and the like. Moreover, the method 100 may allow creation of PHR that may be customizable for individual patient.

At 105 includes presenting the user with a choice of accessing patient data from a local file (e.g., stored in CD or portable digital storage media) or from a server. If the user decides to load the local file, then at 107 the user selects which file to display. At 109 the system checks whether the file is encrypted. If the selected file is not encrypted, then at 117 the CCR record is opened. In one embodiment, the CCR record may be implemented as a Continuity of Care Document (CCD). A CCD may be defined as a representation or mapping of CCR data (ASTM's) within HL7's Clinical Document Architecture (CDA). If the file is encrypted, the user enters a decryption key (111) which may be printed, for example, on the patient's health insurance card. The system then checks whether the entered encryption key is correct (113). If it is not, the system displays an error message (115) and the user is taken back to the initial screen (103). If the encryption key entered is correct, then the CCR or CCD record is opened (117).

In the event that the user selects the option of retrieving the patient data from a server, then the user has to be validated (121) after entering an username and password as well as the patient's name or other information that may be used to identify the patient, such as for example, a health insurance policy number or the like (119). If the user cannot be validated, the system displays an error message (125) and the user is taken back to the initial screen (103). If the user is validated, then the user can select a medical record corresponding to the patient (127) and download the same in XML format, for example (129). At 131, the patient's medical record may be displayed as a CCR or CCD.

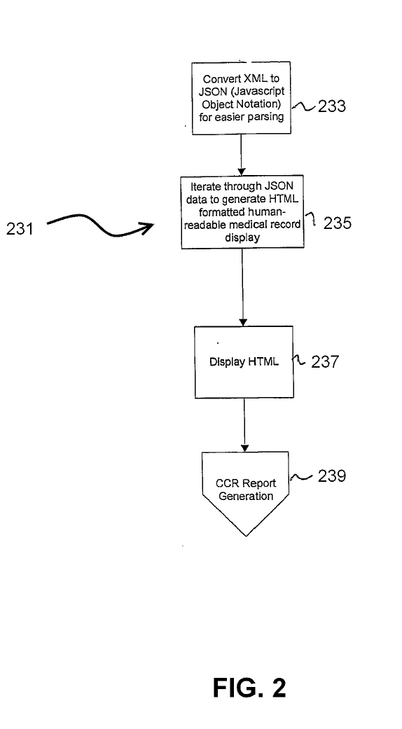

FIG. 2 illustrates a method 231 for processing patient medical data in accordance with one embodiment of the subject matter disclosed herein. Referring to FIG. 2, at 233 the data retrieved from either the local file or the server is converted from XML to JavaScript Object Notation (JSON). One advantage of this conversion is that it makes the data easier to parse. At 235, the JSON data is iterated to generate HTML formatted data. At 237 the process 231 includes displaying an HTML document. Optionally, the document displayed in 237 may be any web browser. The process 231 moves along and at 239 the process 231 includes displaying the HTML data and organizing the same in a CCR Report.

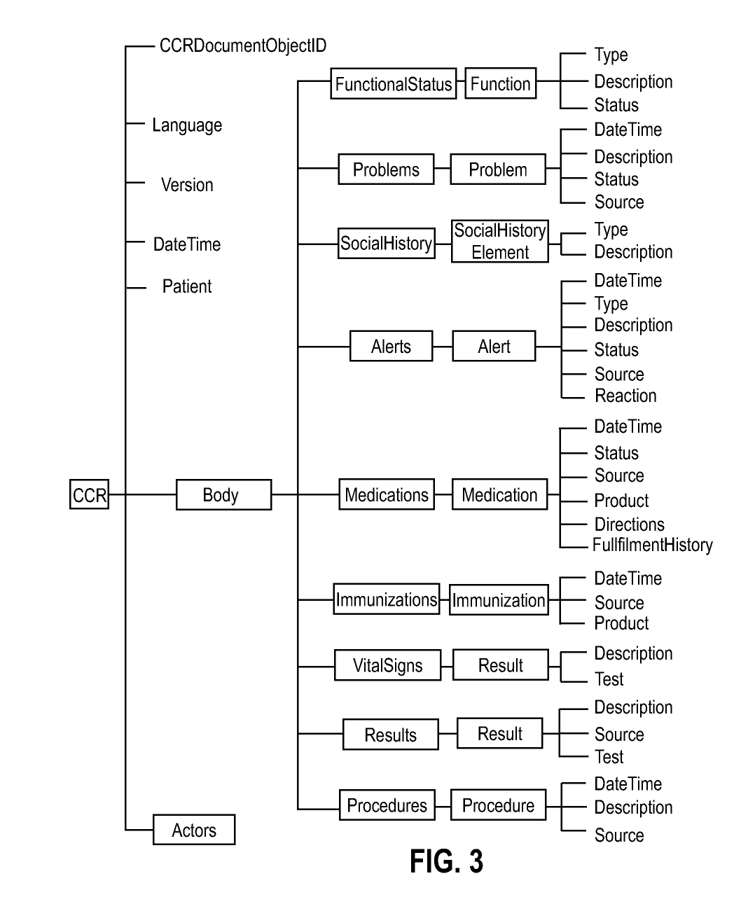

FIG. 3 illustrates fields in the CCR report that may be displayed to a healthcare practitioner in accordance with an embodiment. For example, one source of references to the definition of fields may be found at http://code.google.com/apis/health/ccrg_reference.html.

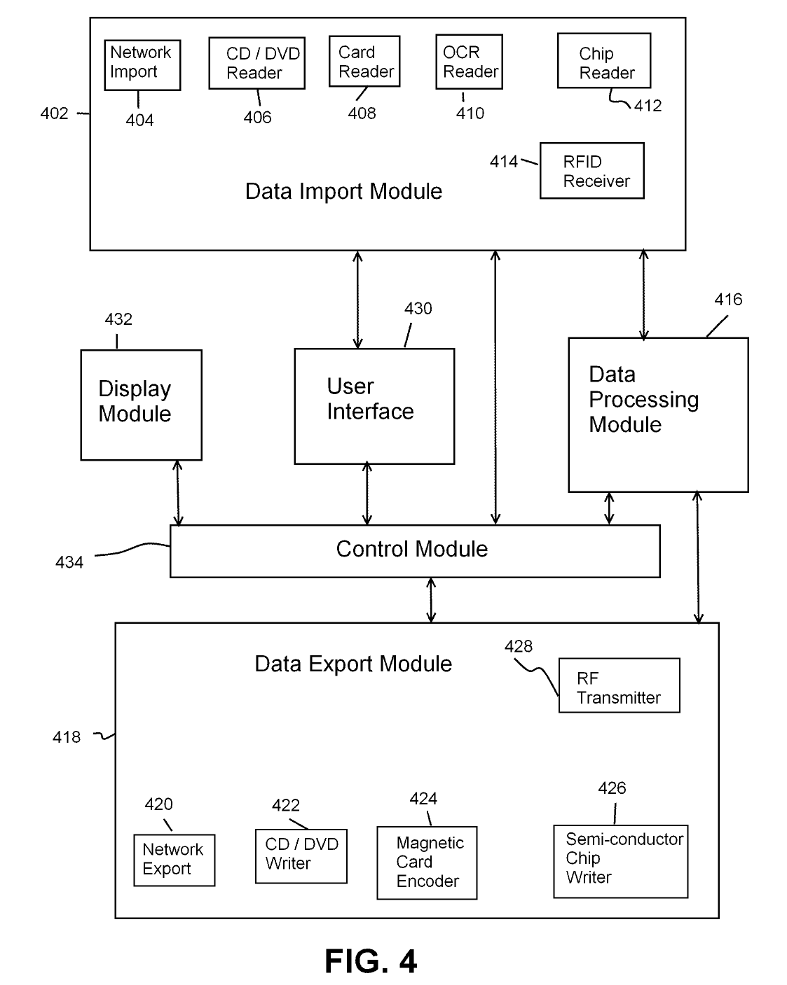

FIG. 4 is an exemplary embodiment of a medical data encoding system 400. The medical data encoding system 400 may include a data import module 402. The data import module allows the system 400 to import any format of medical data for processing. The data import module may have network import 404 adaptor for accessing any medical data format over a network. For example, the network may be a wired or wireless network. Optionally, the network import 404 may be a port accessing a proprietary HIS.

The data import module 402 may also have a CD/DVD reader 406 for importing data using a disc. Furthermore, the data import module 402 may include a card reader 408, an OCR scanner 410 for extracting text from scanned images to be formatted into CCR format. Optionally, the data import module 402 may also have chip reader for reading any form of semiconductor chip or an RFID receiver 414 for reading from an RFID transmitter. It should be noted that other forms of import capabilities may be present that may allow the system 400 to import medical data.

The system 400 may also include a data processing module 416. The data processing module 416, in one embodiment, is configured to format the medical data from a first format into a Continuity of Care Record (CCR) standard. For example, the first format may be a scan of charts, scan of old medical records, a doctor's transcript, digital communication in medicine (DICOM) data, an electronic medical record (EMR), or any combination thereof.

Additionally, the system 400 may include a data export module 418. The data export module may further have a network export 420 component, a CD and/or a DVD writer for writing the medical data on the CD and DVD, a magnetic card encoder 424, a semiconductor chip writer 426 for writing medical data onto semiconductor chips, a RF transmitter 428 for transmitting medical data using radio frequency and the like.

The data export module 418 may be configured to export software along with the CCR formatted medical data. The software exported by the data export module 418 may allow displaying the exported medical data in a browser. For example, the software may be configured to launch the default browser of a system that the software. Optionally, the software may establish connection to a HIS to upload new patient data or if the data already exists in the HIS, the software may merge the existing patient's medical data with the newly exported medical data. The software may be coded such that the sharing of medical data with HIS is selective. For example, the medical data shared with HIS may be data that is relevant to a medical procedure that may be performed on the patient. The execution of the software is independent of an operating system. For example, the system on which the software is being executed.

The data export module 418 exports the medical data to a semiconductor chip. In one embodiment, the semiconductor chip may also be a RFID chip that may transmit the medical data to a RF receiver. Optionally, the data export module 418 exports the medical data to a medical insurance card. The system 400 may optionally be used such that the data export module 418 exports the medical data to a compact disc. In one embodiment the CCR format may be exported as a Continuity of Care Document (CCD). Alternatively, the data export module 418 exports medical data to a Healthcare Information System (HIS), the HIS configured to selectively share a medical data. In yet another embodiment, the data export module 418 may be configured to merge the exported medical data with an existing medical data on the HIS.

The system 400 may also include a user interface 430 to allow a user to interactively communicate with the system 400. The user interface 430 provides interfaces for interacting with a user, such as receiving user inputs. The user interface 430 includes a plurality of user inputs and/or controls, which may be of different types, and are configured to receive commands from a user or operator. For example, the user interface 430 may include a plurality of “soft” buttons, for example, toggle buttons and a keyboard, for example, an alphanumeric keyboard. Additionally, a functional keyboard portion may be provided that includes other user selectable buttons and controls. Other user controls also may be provided, such as a trackball having a trackball ring and a plurality of associated buttons, which may be activated by the fingers of a user when operating the trackball. A plurality of sliding control members (e.g., time control gain potentiometers) may also be provided, for example, adjacent the keyboard.

The system 400 may have a display module 432. In one embodiment, the display module 432 may be part of the user interface 430. Optionally, the display module 432 may be independent from the user interface 430. In one embodiment, the display may be used to communicate to the user the status of a process of procedure being performed using the system 400. Optionally, the display may be an input device such as a touch screen display having soft keys. The system 400 may further include a control module 434 for providing operational instruction to at least the data import module 402, the data processing module 416, the data export module 418, the user interface 430 and the display module 432.

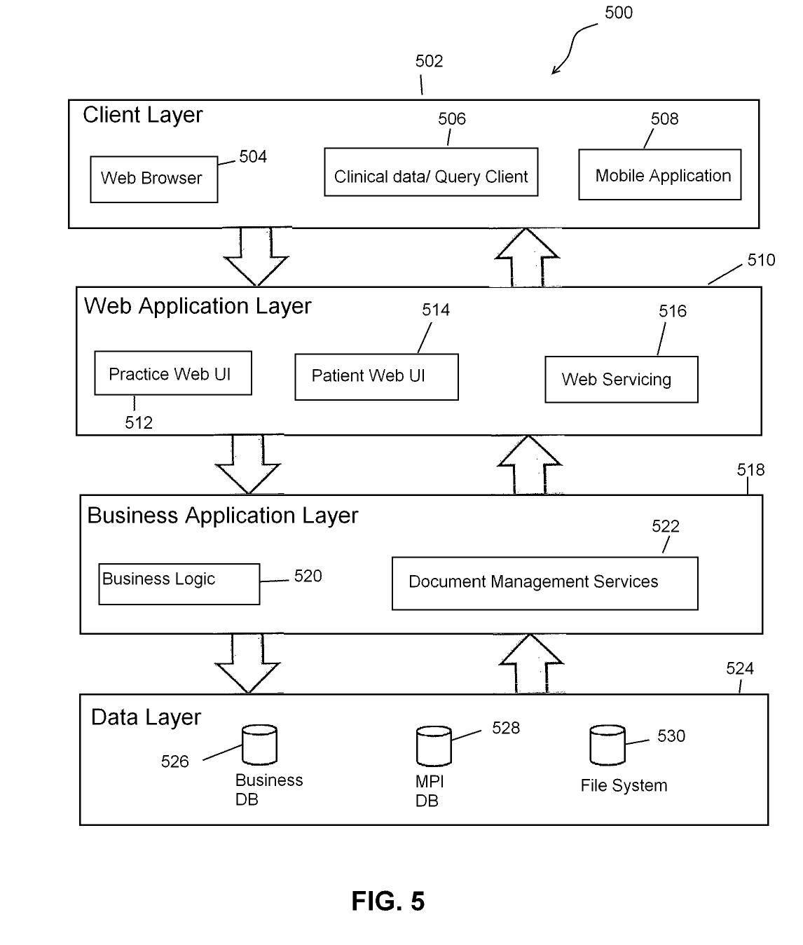

FIG. 5 illustrates an implementation of a communication application process 500 in accordance with an embodiment. In one embodiment, a top level client layer 502 may be provided. The client layer 502 may act as a front end for a user interaction with the medical data encoding system 400. The client layer 502 may have a web browser 504 as front end. For example, the medical data encoding system 400 may be configured so that the web browser may be independent of an operating system. For example, the process 100, 500 may be configured to work with a plurality of web browsers. The web browser may also have plurality of plug-ins, add-ons or other software to provide user interface mechanism.

In an exemplary embodiment, the client layer 502 may also have a clinical data upload/query client 506. For example, the clinical data upload client 506 may be a web based client. For example, the clinical data upload client 506 may be part of the HIS. For example, the clinical data upload client 506 may be HTML base forms. The data entered using the clinical data upload/query client 506 may be used to add medical data for export. Optionally, the data entered using the clinical data upload/query client 506 may be used to search medical data for a patient's record or perform any other kind of query.

In one embodiment, the client layer 502 may also have a mobile application 508 for allowing users to interact with the medical data encoding system 400 via their cell phones. For example, the mobile application 508 may be independent of a cell phone operating system. For example, the mobile application 508 may be configured to run on a Mac operating system, Linux operating system, Android operating system, Windows operating system or the like.

The communication application process 500 may next have a web application layer 510. The web application layer 510 may have a practice web user interface (UI) 512, providing medical professionals a UI for interacting with the medical data encoding system 400. Additionally, the web application layer 510 may have a patient web UI 514, providing an individual patient a UI for interacting with the medical data encoding system 400. In one embodiment, the web application layer 510 may have a web servicing module 516 to support interoperable machine-to-machine interaction over a network.

In an exemplary embodiment, the communication application process 500 may have another layer namely a business application layer 518. The business application layer may have a business logic module 520 allowing access to an underlying database via an interface. Additionally, the business logic module 520 may provide support for business application available through a client layer 502. For example, the business logic module 520 may provide billing support for the medical data encoding system 400. Furthermore, the business application layer 518 may have a document management services 522 providing document submission service, document indexing service, document encrypting service and the like.

Finally, the communication application process 500 may have a data layer 524 for maintaining database and other file systems for the medical data encoding system 400. The data layer 524 may have a business database (DB) for maintaining data related to e-commerce. The data layer 524 may further have a master patient index (MPI) DB providing indexing for all documents in a DB. For example, the MPI DB may be used to support document management services 522. Optionally, the data layer 524 may have file system 530 that may store client data for the medical data encoding system 400. For example, the file system 530 may be a proprietary file system. Optionally, the file system may be maintained in a CCR standard. Optionally, the file system may be a C like file format (CLIF) file system.

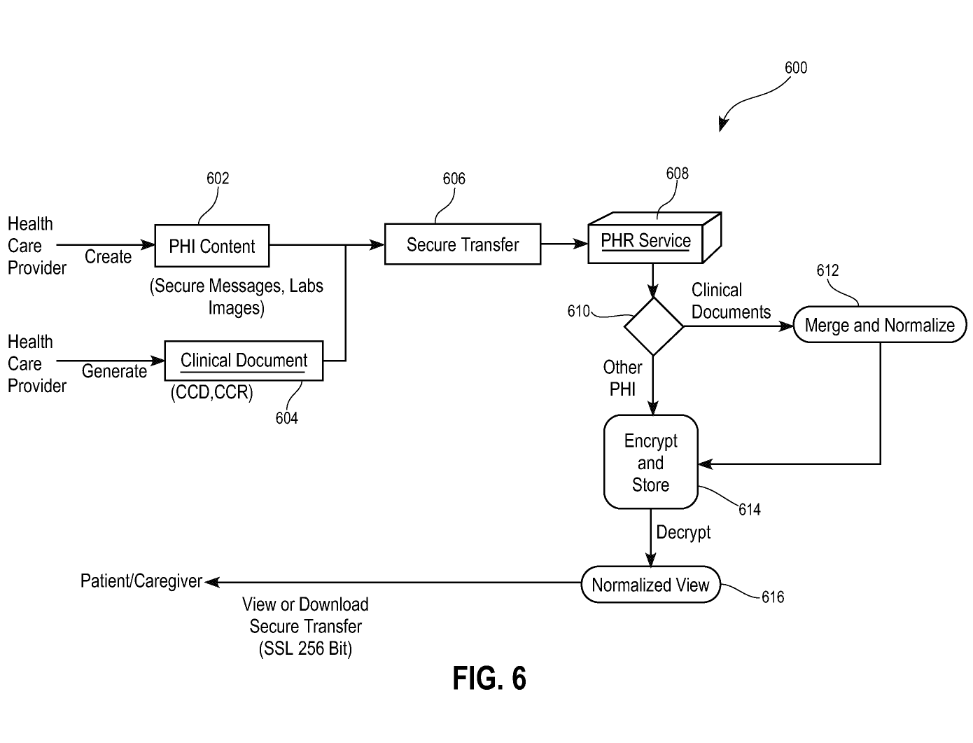

FIG. 6 illustrates a process 600 to store and retrieve medical data in accordance with an embodiment. The process 600 may start at 602 where a healthcare provider may create protected health information (PHI) content. For example, the PHI may contain doctors' transcripts, clinical law results, diagnostic images, and the like. At 604, the process 600 may include generating clinical documents in a CCR format. For example, the CCR formatted document may be a CCD. Next, the process 600 involves transferring the PHI content and/or clinical documents over a secure network. In one embodiment, the PHI contents and/or clinical documents may be transferred using a cryptographic protocol that provides communication security over the Internet. For example, the protocol may be a secure sockets layer (SSL) protocol or a transport layer security (TLS) protocol.

The process 600 flows to 608, where the data is received in a HIS. For example, the HIS may be a PHR. At 610, the process 600 involves a decision where the process 600 determines if the data received is a clinical document or other PHI. When the data received is a clinical document, the process 600 may merge and normalize the clinical document with the existing clinical document for a patient at 612. After merging and normalizing the document the flow moves to 614 where the merged and normalized document is encrypted and stored. Returning to 610, when the data received is other PHI data the flow moves to 614, at 614 the other PHI data is encrypted and stored. For example, the encrypted data may be stored in a DB. Optionally, the encrypted data may be stored in a file system. The encrypted stored data may be accessible over the network by a patient or caregiver via a normalized viewer at 616.

In the following detailed description, reference to medical procedures shall be given the broadest reasonable meaning. The term medical procedure shall include any activity directed at or performed on an individual with the object of improving health, treating disease or injury, or making a diagnosis and the like. For example, the medical procedure may be one where the patient is exposed to an electrical field, such as Electroneuronography, EEG topography, Electrical impedance tomography or the like. For example, the medical procedure may be one where the patient is exposed to a magnetic field, such as Magnetoencephalography, Magnetic therapy, Magnetic resonance imaging and the like. Alternatively, the medical procedure may involve introducing the individual to electromagnetic radiation, such as Scintillography, pulsed electromagnetic fields (PEMF) and the like. The medical procedure may further involve procedures that do not fall within the realm of conventional medicine. The medical procedures may also encompass surgical procedures, clinical examinations, therapies and the like. As used herein, the term “command” and the term “signal” may be used interchangeably.

The various embodiments and/or components, for example, the modules, elements, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as an optical disk drive, solid state disk drive (e.g., flash RAM), and the like. The storage device may also be other similar means for loading computer programs or other instructions into the computer or processor.

As used herein, the term “computer” or “module” may include any processor-based or microprocessor-based system including systems using microcontrollers, reduced instruction set computers (RISC), application specific integrated circuits (ASICs), field-programmable gate arrays (FPGAs), graphical data processing modules (GPUs), logic circuits, and any other circuit or processor capable of executing the functions described herein. The above examples are exemplary only, and are thus not intended to limit in any way the definition and/or meaning of the term “computer”.

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments of the invention. The set of instructions may be in the form of a software program, which may form part of a tangible non-transitory computer readable medium or media. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, the terms “software”, “firmware” and “algorithm” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions, types of materials and coatings described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

What is claimed is:

1. A system for encoding medical data, the system comprising:
a data processing module, wherein the data processing module is configured to format the medical data from a first format into a second format;
a data export module, wherein the data export module exports the medical data in the second format;
a control module for providing operational instruction to at least the data processing module and the data export module.

2. The system of claim 1, wherein the data export module is further configured to export software, the software configured to display the exported medical data in a browser.

3. The system of claim 2, wherein the software is further configured to at least selectively share medical data with a Healthcare Information System (HIS).

4. The system of claim 3 further configured to merge the exported medical data with an existing medical data on the HIS.

5. The system of claim 2, wherein the execution of the software is independent of an operating system.

6. The system of claim 1, wherein the data export module exports the medical data to a semiconductor chip.

7. The system of claim 6, wherein the semiconductor chip may be a radio-frequency identification (RFID) chip.

8. The system of claim 1, wherein the data export module exports the medical data to a medical insurance card.

9. The system of claim 1, wherein the data export module exports the medical data to a compact disc.

10. The system of claim 1, wherein the data export module exports a Continuity of Care Document (CCD).

11. The system of claim 1, wherein the second format is a Continuity of Care Record (CCR) standard

12. The system of claim 1, wherein the data export module exports medical data to a Healthcare Information System (HIS).

13. The system of claim 11 further configured to merge the exported medical data with an existing medical data on the HIS.

14. A method for encoding medical data, the method comprising:
configuring a data processing module to format the medical data from a first format into a second format;
exporting the medical data using a data export module, in the second format;
providing operational instruction to at least the data processing module and the data export module via a control module.

15. The method of claim 13 further comprises configuring the data export module to export software along with CCR standard medical data, the software configured to display the exported medical data in a browser.

16. The method of claim 14 further comprises configuring the software to at least selectively share medical data with a Healthcare Information System (HIS).

17. The method of claim 15 further comprises merging the exported medical data with an existing medical data on the HIS.

18. The method of claim 14 further comprises configuring the software to be standalone, and independent of any operating system.

19. The method of claim 13 further comprises exporting the medical data to a semiconductor chip.

20. The method of claim 13 further comprises exporting the medical data to a medical insurance card.

21. The method of claim 13, wherein the data export module exports medical data to a Healthcare Information System (HIS).

22. The method of claim 20 further configured to merge the medical data exported using the data export module with the existing medical data on HIS.
